(19) United States
(12) Patent Application Publication
(10) Pub. No.: US 2015/0148468 A1
(43) Pub. Date: May 28, 2015

(54) POLYAMIDE COMPOSITIONS

(71) Applicant: LANXESS Deutschland GmbH, Cologne (DE)

(72) Inventors: Timo IMMEL, Dormagen (DE); Jochen ENDTNER, Cologne (DE); Matthias BIENMUELLER, Krefeld (DE)

(21) Appl. No.: 14/548,900

(22) Filed: Nov. 20, 2014

(30) Foreign Application Priority Data
Nov. 28, 2013 (EP) 13194835.8

(51) Int. Cl. C08L 77/06

(52) U.S. Cl. CPC C08L 77/06
USPC 524/222; 524/538; 524/291

(57) ABSTRACT

The invention relates to compositions based on polyamide blends and additives, to the use of these compositions in moulding compositions for production of products having short-term heat distortion resistance, and to a process for producing polyamide-based products having short-term heat distortion resistance, especially for electrics or electronics applications.

The invention relates to compositions based on polyamide blends and additives, to the use of these compositions in moulding compositions for production of products having short-term heat distortion resistance, and to a process for producing polyamide-based products having short-term heat distortion resistance, especially for electrics or electronics applications.

### PRIOR ART

Many electronic and electric assemblies and components include thermally sensitive electric and/or electronic products, particularly heat-sensitive integrated circuits, oscillator crystals and optoelectronic products. In the course of installation of such an assembly, the electrical contacts provided on the products have to be connected in a reliable processing method to conductor tracks on a circuit board and/or to electrical contacts on other products. This installation is frequently effected with the aid of a soldering method, in which solder connections provided on the product are soldered to the circuit board. For each product, there is a safe range for the solder time and solder temperature, in which good solder connections can be produced. In order to achieve a good solder result, the products have to be exposed to elevated temperatures during the soldering over prolonged periods. For example, in the course of wave soldering, the product inserted into the circuit board is first heated up gradually to about 100° C. This is followed by the actual soldering, which is typically effected at 260 to 285° C. and takes at least 5 seconds, followed by the solidification phase, during which the product cools down gradually over several minutes.

According to “http:/de.wikipedia.org/wiki/Wellen%C3% B6ten”, wave soldering, also referred to as flow soldering, is a soldering method by which electronic assemblies (circuit boards, flat assemblies) are soldered in a semiautomatic or fully automatic manner after fitting. The solder side of the circuit board is first wetted with a flux in the fluxer. Thereafter, the circuit board is preheated by means of convection heating (swirling of the heat, as a result of which the same temperature is present virtually everywhere, even on the upper side), coil heating or infrared radiators. This is done firstly in order to vaporize the solvent content of the flux (otherwise bubbles will be formed in the soldering operation), to increase the chemical efficacy of the activators, and to avoid thermal warpage of the assembly and damage to the components as a result of an excessively steep temperature rise in the course of subsequent soldering.

Exact data are found through temperature profiles. This involves mounting temperature sensors at relevant points on a specimen circuit board and recording with a measuring instrument. This gives temperature curves for the upper side of the circuit board and lower side of the circuit board for selected components. Thereafter, the assembly is run over one or two solder waves. The solder wave is generated by pumping liquid solder through an orifice. The solder temperature is about 250° C. in the case of lead-containing solders, and about 10° C. to 35° C. higher in the case of lead-free solders which are to be used with preference due to the avoidance of lead-containing vapours, i.e. 260° C. to 285° C.

The solder time should be selected such that the heating damages neither the circuit board nor the heat-sensitive components. The solder time is the contact time with the liquid solder per solder site. The guideline times for circuit boards laminated on one side are less than one second, and for circuit boards laminated on both sides not more than two seconds. In the case of multiple circuit boards, individual solder times of up to six seconds apply. According to DIN EN 61760-1: 1998, the maximum period for one wave or else two waves together is 10 seconds. More specific details can be taken from the abovementioned reference. After the soldering, cooling of the assembly is advisable, in order to rapidly reduce the thermal stress again. This is accomplished via direct cooling by means of a cooling unit (climate control system) immediately downstream of the soldering region and/or by means of conventional ventilators in the sink station or a cooling tunnel on the return belt.

The result is high demands in terms of short-term heat distortion resistance on the materials used, especially for the lead-free solders which have elevated melting ranges and are being used ever more frequently for environmental reasons. In addition, materials of this kind must have very good ageing resistance under the temperatures that occur in use.

Thermoplastic polyamides such as nylon-6 (PA6) and nylon-6,6 (PA66) are particularly suitable for electrics and electronics applications because of their good processibility, high mechanical durability, and resistance to a multitude of process chemicals, but especially also because of their high hydrolysis stability. This applies especially to applications in the outdoor sector. However, purely aliphatic polyamides such as PA6 or PA66, because of their respective melting ranges around 220° C. and 260° C., rapidly meet their limits when process steps having temperatures above the melting point of these polyamides occur in the production process of electrical or electronic products—for instance in the case of soldering with lead-free solders.

EP 0 997 496 A1 discloses weldable (vibration welding) compositions comprising a mixture of PA66, PA6T/12, glass fibres and a thermal stabilizer (Cul/KI).

WO 2011/126794 A2 describes compositions based on PA66, PA6T/66 and optionally PA61/6T, comprising glass fibres and thermal stabilizers such as boehmite and zinc borate, having good surface appearance, acceptable flame-retardant properties and high gloss retention at high temperatures and under moist conditions.

WO 2013/188488 A2 gives examples of compositions comprising PA66, PA66/6T and optionally PA6, additionally glass fibres and a copper-based thermal stabilizer. These exhibit high tensile strengths after oven ageing.

WO2004/090036 A1 describes the production of glass fibre-reinforced, thermally stabilized, flame-retardant polyamide mouldings for the electrics and electronics industry, for example components which are mounted on printed circuit boards by the surface mounting technique with lead-free solder materials. For this purpose, compositions composed of PA6T/66, a flame retardant (aluminium dimethylphosphinate), glass fibres, a thermal stabilizer (Irganox® 1098) and a lubricant (calcium stearate) are proposed.

WO 99/45070 A1 discloses high-melting polyamide compositions for electronics applications, based, inter alia, on a polyamide having a melting point of at least 280° C., a thermoplastic having a melting point below 230° C., a halogenated organic compound and an inorganic reinforcer.

WO 2013/014144 A1 describes flame-retardant polymer compositions based on semicrystalline semiaromatic polyamides, and also semicrystalline aliphatic polyamides and a halogen-free flame retardant. In the examples, there are combinations of PA4T/66 with PA46 and PA4T/66 with PA66.

Finally, reference is made to G. Lau, Material Selection of Electronic Components—Zytel® High Temperature Nylon HTN and Zenite® LCP, Power Electronics Systems and Applications, 2006, ICPESA '06, 2nd International Conference on Nov. 1, 2006, in which Zytel® represents PA66 and HTN represents PA6T.

If the prior art is taken into account, it would be possible to switch to nylon-4,6 (PA46) having a melting range around 290° C., among the aliphatic polyamides, for the high short-term temperatures which occur in soldering processes for the purpose of production of electronic products. However, at the processing temperatures recommended for PA46, ideally between 310 and 320° C., the choice of suitable additives is very limited. This is especially true of flame retardants that are thermally sensitive but can still be used efficiently in PA66, for example, such as, in particular, red phosphorus, melamine polyphosphate or aluminium tris(diethylphosphinate). When these flame retardants are used in PA46, because of the higher processing temperatures, there is an increased risk of breakdown of such additives and hence, for example, an increased tendency to metal corrosion, for example in the case of processing of, for example, plastic-metal hybrid products, or to formation of deposits. A further difficulty with PA46 is the increase in water absorption compared to PA6 and PA66, which additionally also results in a more significant change in dimensions in the products produced from PA46.

As an alternative to PA46, a switch to semicrystalline semiaromatic polyamides is conceivable, as obtainable, for example, through incorporation of terephthalic acid into the polyamide structure. Examples of these are PA6T/6, PA6T/66 or PA6T/61/66, where “T” represents terephthalic acid, “I” represents isophthalic acid and “/” represents a copolymer. These materials offer the advantage over PA46 of lower water absorption. It is also possible to attain melting ranges above 300° C. As well as the restrictions mentioned for PA46 with regard to thermally sensitive adhesives, however, restrictions because of the distinctly higher melt viscosity and a reduced crystallization rate also have to be taken into account in the case of the semiaromatic polyamides (Ludwig Bottenbruch, Rudolf Binsack (eds.): Technische Thermoplaste [Industrial Thermoplastics] Part 4, Polyamide [Polyamides], Hanser Verlag Munich, p. 803-809).

It was therefore an object of the present invention to provide compositions based on thermoplastic polyamides which, on the one hand, have an improved short-term heat distortion resistance compared to PA66 but, on the other hand, are processible with the low temperatures customary for PA66, and as a result have fewer restrictions in the choice of thermally sensitive additives, especially flame retardants, and have good mechanical properties and, in the case of the products to be produced from the compositions in soldering processes, have a high short-term heat distortion resistance.

In the context of the present invention, short-term heat distortion resistance at a defined temperature for PA66-based products is when a test specimen of dimensions 20·13·1.5 mm having right-angled corners and edges does not undergo any change in shape on a glass plate at the above-defined temperature for 15 min, and additionally does not show any adhesion to the glass plate. For the test, the test specimen, lying flat on the glass plate, is introduced into a conventional hot air oven preheated to the target temperature for 15 min and then cooled back down to room temperature [23° C.+/−2° C.] by the surrounding air having the temperature of 23° C.+/−2° C. No change in shape in the context of the present invention, or short-term heat distortion resistance, occurs when the corers and edges of the test specimen after the heated storage do not have any rounding above a radius of 0.8 mm. The radius indicates the degree of rounding of a corner or edge by describing the size of an imaginary circle which can thus be placed into a corner or edge of the test specimen such that the imaginary circle represents the rounding. The greater the radius, the rounder are the corners or edges. No adhesion exists in the context of the present invention when the test specimen falls off the glass plate after it has been inclined from the horizontal by 90° to the vertical.

In this regard, see also the chapter “Ändern des Eckenradius von abgerundetn Rechtecken” [Changing the Corner Radius of Rounded Rectangles]: http://help.adobe.com/de_DE/framemaker/using/WSd817046a44e105e21e63e3d11abf7960b-7f38.html.

Good properties in the context of the present invention, in the case of products to be produced, are characterized especially by high mechanical values in flexural strength and flexural modulus, a maximum heat distortion resistance (HDT A value) and, in relation to flame retardancy, by high GWIT values. High GWIT values in the context of the present invention are values equal to or above 750° C. High values in relation to flexural strength are 228 MPa or higher. High values in relation to heat distortion resistance are 227° C. or higher.

Flexural strength in technical mechanics is a value for a flexural strength which, when exceeded in a component under flexural stress, causes failure as a result of fracture of the component. It describes the resistance that a workpiece offers to flexing or fracture thereof. In the short-term bending test to ISO 178, bar-shaped specimens, preferably having the dimensions 80 mm·10 mm·4 mm, are placed with their ends on two supports and loaded with a flexing ram in the middle (Bodo Carlowitz: Tabellarische Übersicht über die Prüfung von Kunststoffen [Tabular Overview of the Testing of Plastics], 6th edition, Giesel-Verlag für Publizität, 1992, p. 16-17).

According to “http://de.wikipedia.org/wiki/Biegeversuch”, the flexural modulus is determined in a 3-point bending test, by positioning a test specimen on two rests and loading it with a test ram in the middle. This is probably the most commonly used form of flexural test. The flexural modulus is then calculated in the case of a flat sample as follows:

E=Iᵥ³(X_{H}−X_{L})/4D_{L}ba³

where E=flexural modulus in kN/mm²: Iᵥ=support width in mm; X_{H}=end of flexural modulus determination in kN; X_{L}=start of flexural modulus determination in kN; D_{L}=a deflection in mm between X_{H} and X_{L}; b=sample width in mm; a=sample thickness in mm.

Heat distortion resistance is a measure of the thermal durability of plastics. Because they have viscoelastic material characteristics, there is no strictly defined upper use temperature for plastics; instead, a substitute parameter is determined under defined load. One method is the testing of heat distortion resistance to DIN EN ISO 75-1, -2, -3 (precursor: DIN 53461), according to which the heat distortion resistance temperature is determined by using a standard test specimen with rectangular cross section, which is subjected to three-point bending under constant load, preferably with its edges flat. According to the test specimen height, an edge fibre strain or of 1.80 N/mm² (Method A) is achieved by using weights or/and springs to apply a force

F=2rbh^{2/3}L

where b=specimen width, h=specimen height and L=distance between rests. See also: http//de.wikipedia.org/wiki/W%C3% A4rmeformbest%C3%A4ndigkeit.

Subsequently, the stressed samples are subjected to heating at a constant heating rate of 120 K/h (or 50 K/h). If the deflection of the sample reaches an edge fibre elongation of 0.2%, the corresponding temperature is the heat distortion resistance temperature HDT (heat deflection temperature or heat distortion temperature).

The GWIT value is ascertained by glow wire tests on end products and materials to IEC 60695-2-13. European Standard EN 60335-1 “Household and similar electrical appliances—Safety—Part 1: General requirements” contains, in section 30, “Resistance against Fire and Heat”, specific safety requirements that have to be fulfilled with the aid of the test described in EN/IEC 606952-10 to 13, and IEC 60695-2-13 relates to the glow wire tests for the ignitability of materials (GWIT). For unsupervised domestic appliances >0.2 A, according to EN 60335-1, Section 30, the IEC 60695-2-13 requirement is for ignitability of materials (GWIT) at 775° C. of <5 s.

The test procedure in the GWIT test is as follows: The samples are exposed to the glow wire for 30 s in 50° C. steps from 500 to 900° C. and at 960° C. The sample is classified as having ignited if it burns for more than 5 s. The temperature at which the material does not ignite in 3 attempts (example: 750° C.) +25 K is referred to as GWIT (775° C.).

The 5 s ignitability requirement is very strict, and some flame-retardant plastics that attain the UL94 V-0 classification fail since they are not extinguished until shortly after the 5 s. Plastics having flame retardants that act in the gas phase are particularly affected here.

In order to improve the GWIT test, a cooperative test was conducted in 2007, involving the industry and VDE (Verband der Elektrotechnik Elektronik Informationstechnik e.V., German Association for Electrical, Electronic and Information Technologies). The results were considered as part of an international IECITC 89 cooperative test, one purpose of which was to improve the GWIT test method. The cooperative tests showed that the test environment, test chamber, glow wire and temperature measurement are not defined accurately and can lead to variable results. With the exception of corona phenomena, which are no longer considered as flames, the findings obtained, however, are very unlikely to lead to major changes in the revisions of the GWIT standards.

The solution to the problem and the subject-matter of the present invention are compositions comprising
a) 15% to 90% by weight, preferably 20% to 70% by weight, more preferably 30% to 60% by weight, of nylon-6,6,
b) 3% to 30% by weight, preferably 5% to 25% by weight, more preferably 10% to 20% by weight, of at least one thermoplastic polyamide from the group of nylon-4,6 and/or the semiaromatic copolyamides containing terephthalic acid as monomer unit and having a melting point in the range from 270° C. to 330° C. where the proportion of component b) or components b), based on the sum total of all the thermoplastic polymers present in the composition, is 5% to 40% by weight, preferably 10% to 30% by weight, more preferably 15%-25% by weight,
c) 5% to 70% by weight, preferably 10% to 45% by weight, more preferably 15% to 35% by weight, of glass fibres, and
d) 0.01% to 3% by weight, preferably 0.05% to 1.5% by weight, more preferably 0.1% to 0.8% by weight, of at least one thermal stabilizer,
   where the sum total of all the percentages by weight of the components is always 100.

The solution to the problem and the subject-matter of the present invention are also compositions comprising
a) 15% to 91.99% by weight, preferably 20% to 70% by weight, more preferably 30% to 60% by weight, of nylon-6,6,
b) 3% to 30% by weight, preferably 5% to 25% by weight, more preferably 10% to 20% by weight, of nylon-4,6,
c) 5% to 70% by weight, preferably 10% to 45% by weight, more preferably 15% to 35% by weight, of glass fibres, and
d) 0.01% to 3% by weight, preferably 0.05% to 1.5% by weight, more preferably 0.1% to 0.8% by weight, of at least one thermal stabilizer,
   where the sum total of all the percentages by weight of the components is 100.

For clarity, it should be noted that the scope of the present invention encompasses all the definitions and parameters mentioned hereinafter in general terms or specified within areas of preference, in any desired combinations. Unless stated otherwise, all figures are based on room temperature (RT)=23+/−2° C. and on standard pressure, 1 bar.

In addition, for clarity, it should be noted that the compositions, in a preferred embodiment, may be mixtures of components a), b), c) and d), and also thermoplastic moulding compositions that can be produced from these mixtures by means of processing operations, preferably by means of at least one mixing or kneading apparatus, but also products that can be produced from these in turn, especially by extrusion or injection moulding.

The inventive compositions are formulated for further utilization by mixing the components a), b), c) and d) for use as reactants in at least one mixing apparatus. This gives, as intermediates, moulding compositions based on the inventive compositions. These moulding compositions—also referred to as thermoplastic moulding compositions—may either consist exclusively of components a), b), c) and d), or else contain further components in addition to components a), b), c) and d). In this case, at least one of components a), b), c) and d) should be varied within the scope of the ranges specified such that the sum total of all the percentages by weight is always 100.

In the case of thermoplastic moulding compositions and products that can be produced therefrom, the proportion of the inventive compositions therein is preferably in the range from 50% to 100% by weight, preferably in the range from 90% to 100% by weight, the further components or other constituents being additives selected by the person skilled in the art in accordance with the later use of the products, preferably from at least one of components e) to h) defined hereinafter.

Unless stated otherwise, all melting point figures given for the semicrystalline thermoplastics mentioned here are based on the capillary tube and polarization microscope method according to ISO 3146, or on determination via dynamic differential calorimetry (DSC), it being necessary for one alternative mentioned to be fulfilled. The determination of the melting point by DSC is effected in this case on a Mettler DSC822e instrument. At a heating rate of 20° C./min, the melting point is read off as the peak of the first heating operation, and the instrument is programmed such that it runs through a temperature range from 25° C. to 360° C. The person skilled in the art is aware of the processes mentioned; reference is made here, inter alia, to http://amozeshi.aliexirs.ir/Kunststoff-Lexikon.html.

Component a)

PA66 [CAS No. 32131-17-2], which is to be used as component a), is a semicrystalline polyamide and is prepared from hexamethylenediamine (HMD) and adipic acid. It forms through a polycondensation with elimination of water and has a melting point of 260° C. The nomenclature of the polyamides in the context of the present invention corresponds to the international standard, the first number(s) indicating the number of carbon atoms in the starting diamine and the last number(s) the number of carbon atoms in the dicarboxylic acid. If only one number is mentioned, this means that the starting material was an α,ω-aminocarboxylic acid or the lactam derived therefrom; for further information, reference is made to H. Domininghaus, Die Kunststoffe und ihre Eigenschaften [The Polymers and Their Properties], pages 272 f., VDI-Verlag, 1976. According to DE 10 2011 084 519 A1, semicrystalline polyamides have an enthalpy of fusion of more than 25 J/g, measured by the DSC method to ISO 11357 in the 2nd heating operation and integration of the melt peak. This distinguishes them from the semicrystalline polyamides having an enthalpy of fusion in the range from 4 to 25 J/g, measured by the DSC method to ISO 11357 in the 2nd heating operation and integration of the melt peak, and from the amorphous polyamides having an enthalpy of fusion of less than 4 J/g, measured by the DSC method to ISO 11357 in the 2nd heating operation and integration of the melt peak. Semicrystalline PA66 for use as component a) in accordance with the invention is obtainable, for example, under the Durethan® A30 name from Lanxess Deutschland GmbH, Cologne, Germany. For clarity, it should be pointed out that the PA66 for use in accordance with the invention is not a copolymer having monomer components different from PA66.

Component b)

As component b), nylon-4.6 (PA46) is used, which can be obtained from tetramethylenediamine and adipic acid [CAS No. 50327-22-511]. PA46 is obtainable, inter alia, from DSM Engineering Plastics, Sittard, the Netherlands, under the Stanyl® name. For clarity, it should be pointed out that the PA46 for use in accordance with the invention is not a copolymer having monomer components different from PA46.

Preferred semiaromatic copolyamides had been found to be those wherein the triamine content is less than 0.5% by weight, preferably less than 0.3% by weight (see EP-A 299 444), especially PA 6T/6 and PA 6T/66. Further polyamides of high thermal stability are known from EP-A 19 94 075. The preferred semiaromatic copolyamides having a low triamine content can be prepared by the processes described in EP-A 129 195 and EP-A 129 196. A copolyamide with terephthalic acid having a melting point in the range from 270° C. to 330° C. which can be used with particular preference in accordance with the invention is PA 6T/6, which is available, for example, under the Ultramid® T name from BASF SE. Ludwigshafen, Germany (see also Ultramid® (PA) main brochure from BASF SE, August 2013). PA 6T/6 is prepared from hexamethylenediamine, terephthalic acid and caprolactam and has a melting point of 295° C. In addition, PA6T/66, PA6T/61 or PA6T/61/66 can be used with particular preference.

Component c)

The glass fibres for use as component c) in accordance with the invention preferably have a fibre diameter in the range from 7 to 18 μm, more preferably in the range from 9 to 15 μm, and are added in the form of continuous fibres or in the form of chopped or ground glass fibres. The fibres are preferably modified with a suitable slip system and an adhesion promoter or adhesion promoter system, more preferably based on silane.

Very particularly preferred silane-based adhesion promoters for the pretreatment are silane compounds of the general formula (I)

(X—CH₂)_{q})k-Si—(O—CrH₂r+1)₄-k (I)

in which the substituents are defined as follows:

### X: NH₂—, HO—,

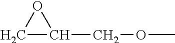

q: an integer from 2 to 10, preferably 3 to 4,
r. an integer from 1 to 5, preferably 1 to 2,
k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane, and the corresponding silanes containing a glycidyl group as the X subsituent.

For the modification of the glass fibres, the silane compounds are preferably used in amounts of 0.05% to 2% by weight, more preferably 0.25% to 1.5% by weight and especially 0.5% to 1% by weight, based on the glass fibres for surface coating.

The glass fibres may, as a result of the processing to give the moulding composition or the product to be produced therefrom, have a lower d97 or d50 value in the moulding composition or in the product than the glass fibres originally used. The glass fibres may, as a result of the processing to give the moulding composition or to give the shaped body, have shorter length distributions in the moulding composition or in the shaped body than originally used.

Component d)

As component d), at least one thermal stabilizer is used. Thermal stabilizers which can be selected with preference are selected from the group of the sterically hindered phenols, which are compounds having phenolic structure and having at least one sterically demanding group on the phenolic ring. Sterically demanding groups in the context of the present invention are preferably tert-butyl groups, isopropyl groups, and aryl groups substituted by sterically demanding groups. Sterically demanding groups in the context of the present invention are especially tert-butyl groups. Particularly preferred thermal stabilizers are sterically hindered phenols containing at least one structure of the formula (II)

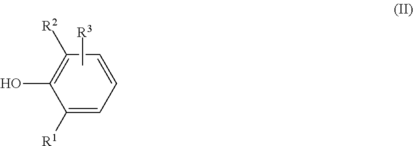

in which R¹ and R² are each an alkyl group, a substituted alkyl group or a substituted triazole group, where the R¹ and R² radicals may be the same or different and R³ is an alkyl group, a substituted alkyl group, an alkoxy group or a substituted amino group. Very particularly preferred thermal stabilizers of the formula (II) are described as antioxidants, for example, in DE-A 27 02 661 (U.S. Pat. No. 4,360,617), the content of which is encompassed in full by the present application. A further group of preferred sterically hindered phenols is derived from substituted benzenecarboxylic acids, especially from substituted benzenepropionic acids. Particularly preferred compounds from this class are compounds of the formula (III)

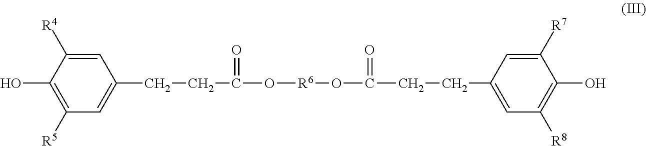

where R⁴, R⁵, R⁷ and R⁸ are each independently C₁-C₈-alkyl groups which may themselves be substituted, at least one of these being a sterically demanding group, and R⁶ is a divalent aliphatic radical having 1 to 10 carbon atoms, which may also have C—O bonds in the main chain. Examples of compounds of the formula (III) are compounds of the formulae (IV), (V) and (VI).

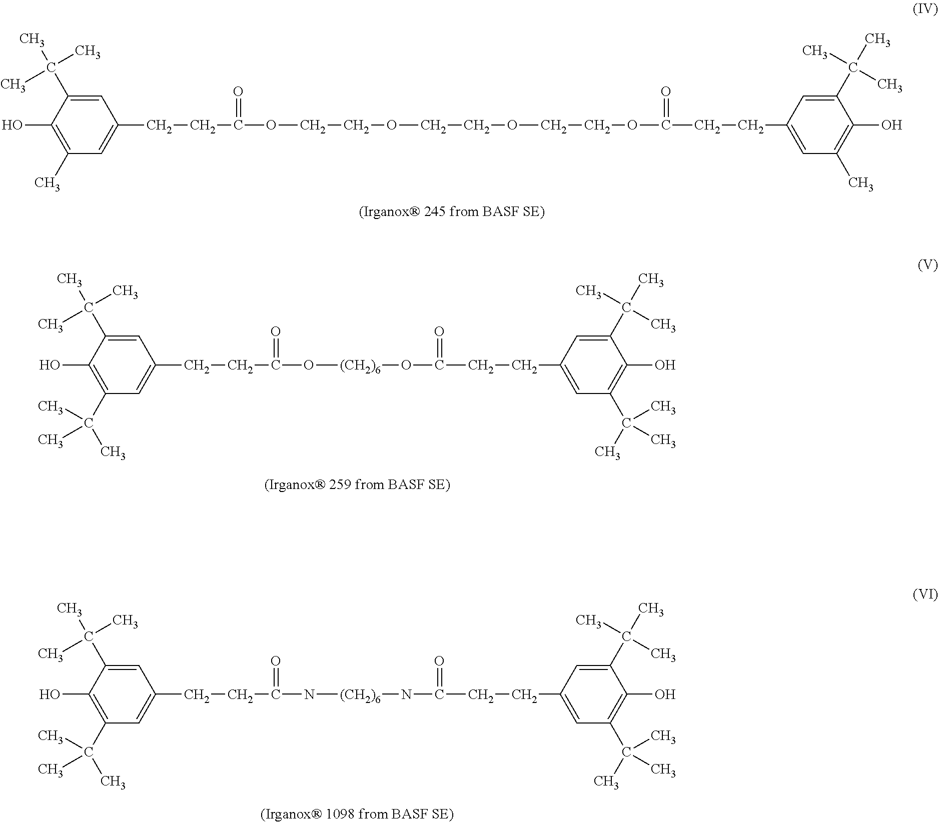

Very particularly preferred thermal stabilizers are selected from the group of 2,2′-methylenebis(4-methyl-6-tert-butylphenol), 1,6-hexanediyl bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 35-di-tert-butyl-4-hydroxybenzyldimethylamine.

Especially preferred thermal stabilizers are selected from the group of 2,2′-methylenebis(4-methyl-6-tert-butylphenol), 1,6-hexanediyl bis[3-(3,5-di-tert-butyl-4-hydroxyphenyl)propionate] (Irganox® 259), pentaerythrityl tetrakis[3-(3,5-di-tert-butyl-4-hydroxyphenyl)propionate] and N,N′-hexamethylenebis-3,5-di-tert-butyl-4-hydroxyhydrocinnamide (Irganox® 1098), and the above-described Irganox® 245 from BASF SE, Ludwigshafen, Germany.

Very particular preference is given in accordance with the invention to using N,N′-hexamethylenebis-3,5-di-tert-butyl-4-hydroxyhydrocinnamide [CAS No. 23128-74-7] as thermal stabilizer, available as Irganox® 1098 from BASF SE, Ludwigshafen, Germany.

Component e)

In a preferred embodiment, the present invention relates to compositions comprising, in addition to components a), b), c) and d), also
e) 0.01% to 5% by weight, preferably 0.5% to 3% by weight, more preferably 1% to 2% by weight, of dipentaerythritol [CAS No. 126-58-9] and/or tripentaerythritol [CAS No. 78-24-0], in which case the level of at least one of components a), b), c) and d) is reduced to such an extent that the sum total of all the percentages by weight is 100.

Component f)

In a preferred embodiment, the present invention relates to compositions comprising, in addition to components a) to e) or instead of component e), also
f) 1% to 55% by weight, preferably 2% to 30% by weight, more preferably 5% to 20% by weight, of at least one flame retardant, in which case the level of at least one of components a), b), c) and d), and if appropriate e), is reduced to such an extent that the sum total of all the percentages by weight is always 100.

Preferred flame retardants are commercial organic halogen compounds with synergists or commercial organic nitrogen compounds or organic/inorganic phosphorus compounds, which are used individually or in a mixture with one another. It is also possible to use mineral flame retardant additives such as magnesium hydroxide or calcium magnesium carbonate hydrates (e.g. DE-A 4 236 122). Halogenated, especially brominated and chlorinated, compounds preferably include ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene and brominated polyphenylene ethers. Suitable phosphorus compounds include the phosphorus compounds according to WO-A 98/17720 (=U.S. Pat. No. 6,538,024), preferably red phosphorus, metal phosphinates, especially aluminium phosphinate or zinc phosphinate, metal phosphonates, especially aluminium phosphonate, calcium phosphonate or zinc phosphonate, derivatives of the 9,10-dihydro-9-oxa-10-phosphaphenanthrene 10-oxides (DOPO derivatives), triphenyl phosphate (TPP), resorcinol bis(diphenyl phosphate) (RDP), including oligomers, and bisphenol A bis(diphenyl phosphate) (BDP) including oligomers, and also zinc bis(diethylphosphinate), aluminium tris(diethylphosphinate), melamine phosphate, melamine pyrophosphate, melamine polyphosphate, melamine poly(aluminium phosphate), melamine poly(zinc phosphate) or phenoxyphosphuzene oligomers and mixtures thereof. Useful nitrogen compounds include especially melamine or melamine cyanurate, reaction products of trichlorotriazine, piperazine and morpholine as per CAS No. 1078142-02-5 (e.g. MCA PPM Triazine HF from MCA Technologies GmbH, Biel-Benken, Switzerland). Suitable synergists are preferably antimony compounds, especially antimony trioxide or antimony pentoxide, zinc compounds, tin compounds, especially zinc stannate, or borates, especially zinc borate.

It is also possible to add what are called carbon formers and tetrafluoroethylene polymers to the flame retardant.

Among the halogenated flame retardants, particular preference is given to using brominated polystyrenes, for example Firemaster® PBS64 (Great Lakes, West Lafayette, USA) or brominated phenylene ethers, each especially preferably in combination with antimony trioxide and/or zinc stannates as synergists. Among the halogenated flame retardants, particular preference is given to using aluminium tris(diethylphosphinate) in combination with melamine polyphosphate (e.g. Melapur® 200/70 from BASF SE. Ludwigshafen, Germany) and zinc borate (e.g. Firebrake® 500 or Firebrake® ZB from RioTinto Minerals, Greenwood Village, USA) or aluminium tris(diethylphosphinate) in combination with aluminium phosphonate and/or aluminium phosphonate hydrate.

Very especially particular preference is given to using, as flame retardant, aluminium tris(diethylphosphinate) (e.g. Exolit® OP1230 from Clariant International Ltd. Muttenz, Switzerland) (CAS No. 225789-38-8) in a combination with melamine polyphosphate (Melapur® 200/70) [(CAS No. 218768-84-4] and/or zinc borate (Firebrake® 500) [CAS No. 1332-07-6].

Component g)

In a preferred embodiment, the inventive compositions comprise, in addition to components a) to f) or instead of components e) and/or f), also
g) 0.01% to 10% by weight, preferably 0.1% to 7% by weight, more preferably 0.5% to 5% by weight, of at least one chain-extending additive from the group of the bisphenol diglycidyl ethers, the epoxy-cresol novolacs or the epoxy-phenol novolacs, in which case the level of at least one of components a), b), c), d) and, if appropriate, e) and/or f), is reduced to such an extent that the sum total of all the percentages by weight is 100.

Epoxy-phenol novolacs or epoxy-cresol novolacs can be obtained as condensation products of, respectively, phenyl and cresol with formaldehyde and subsequent reaction with epichlorohydrin. One example is Araldite® ECN 1280-1 from Huntsman, Everberg, Belgium.

Preference is given to using bisphenol diglycidyl ethers. These can be obtained by reactions of bisphenol derivatives with epichlorohydrin. Preferred bisphenol components are 2,2-bis(4-hydroxyphenyl)propane (bisphenol A), 1,1-bis(4-hydroxyphenyl)-1-phenylethane (bisphenol AP), bis(4-hydroxyphenyl) sulphone (bisphenol S) and bis(4-hydroxydiphenyl)methane (bisphenol F), particular preference being given to bisphenol A.

Very particular preference is given to solid bisphenol A diglycidyl ethers [CAS No. 1675-54-3] having a softening point above 60° C., for example Araldite® GT7071 from Huntsman, Everberg, Belgium.

Component h)

In a preferred embodiment, the inventive compositions comprise, in addition to components a) to g) or instead of components e) and/or f) and/or g), also
h) 0.01% to 20% by weight, preferably 0.01% to 10% by weight, more preferably 0.01% to 5% by weight, of at least one additive other than components c) to g), in which case the level of at least one of components a), b), c), d) and, if appropriate, e) and/or f) and/or g) is reduced to such an extent that the sum total of all the percentages by weight is 100.

Customary additives for component h) are preferably

stabilizers other than component d), demoulding agents, UV stabilizers, gamma ray stabilizers, antistats, flow aids, flame retardants, elastomer modifiers, fire prevention additives, emulsifiers, nucleating agents, acid scavengers, plasticizers, lubricants, dyes or pigments. These and further suitable additives are described, for example, in Gächter, Millier, Kunststoff-Additive [Plastics Additives], 3rd edition, Hanser-Verlag, Munich, Vienna, 1989 and in the Plastics Additives Handbook, 5th Edition, Hanser-Verlag, Munich, 2001. The additives can be used alone or in a mixture, or in the form of masterbatches.

Stabilizers used are preferably sterically hindered phenols, hydroquinones, aromatic secondary amines such as diphenylamines, substituted resorcinols, salicylates, benzotriazoles and benzophenones, and also variously substituted representatives of these groups or mixtures thereof.

Preferred demoulding agents are selected from the group of ester waxes, pentaerythrityl tetrastearate (PETS), long-chain fatty acids, salts of long-chain fatty acids, amide derivatives of long-chain fatty acids or montan waxes, and low molecular weight polyethylene or polypropylene waxes or ethylene homopolymer waxes.

Preferred long-chain fatty acids are stearic acid or behenic acid. Preferred salts of the long-chain fatty acids are calcium stearate or zinc stearate. A preferred amide derivative of long-chain fatty acids is ethylenebisstearylamide [CAS No. 110-30-5]. Preferred montan waxes are mixtures of straight-chain saturated carboxylic acids having chain lengths of 28 to 32 carbon atoms.

Pigments or dyes used may preferably be zinc sulphide, titanium dioxide, ultramarine blue, iron oxide, carbon black, phthalocyanines, quinacridones, perylenes, nigrosin and anthraquinones. Titanium dioxide, which can used with preference as pigment, preferably has a median particle size in the range from 90 nm to 2000 nm. Useful titanium dioxide pigments for the titanium dioxide for use with preference as pigment in accordance with the invention include those whose base structures can be produced by the sulphate (SP) or chloride (CP) method, and which have anatase and/or rutile structure, preferably rutile structure. The base structure need not be stabilized, but preference is given to a specific stabilization: in the case of the CP base structure by an Al doping of 0.3-3.0% by weight (calculated as Al₂O₃) and an oxygen excess in the gas phase in the oxidation of the titanium tetrachloride to titanium dioxide of at least 2%; in the case of the SP base structure by a doping, for example, with Al, Sb, Nb or Zn. More preferably, in order to obtain a sufficiently high brightness of the products to be produced from the inventive compositions, a “light” stabilization with Al is preferred, or compensation with antimony in the case of higher amounts of Al dopant. In the case of use of titanium dioxide as white pigment in paints and coatings, plastics etc., it is known that unwanted photocatalytic reactions caused by UV absorption lead to breakdown of the pigmented material. This involves absorption of light in the near ultraviolet range by titanium dioxide pigments, forming electron-hole pairs, which produce highly reactive free radicals on the titanium dioxide surface. The free radicals formed result in binder degradation in organic media. Preference is given in accordance with the invention to lowering the photoactivity of the titanium dioxide by inorganic aftertreatment thereof, more preferably with oxides of Si and/or Al and/or Zr and/or through the use of Sn compounds.

Preferably, the surface of pigmentary titanium dioxide is covered with amorphous precipitated oxide hydrates of the compounds SiO_and/or Al₂O₃ and/or zirconium oxide. The Al₂O₃ shell facilitates pigment dispersion in the polymer matrix; the SiO₂ shell makes it difficult for charges to be exchanged at the pigment surface and hence prevents polymer degradation.

According to the invention, the titanium dioxide is preferably provided with hydrophilic and/or hydrophobic organic coatings, especially with siloxanes or polyalcohols.

Titanium dioxide [CAS No. 13463-67-7] which can be used as pigment with particular preference as component h) in accordance with the invention preferably has a median particle size in the range from 90 nm to 2000 nm, preferably in the range from 200 nm to 800 nm.

Commercially available products are, for example, Kronos® 2230, Kronos® 2225 and Kronos® vlp7000 from Kronos, Dallas, USA.

Nucleating agents used are preferably talc, sodium phenylphosphinate or calcium phenylphosphinate, aluminium oxide or silicon dioxide, particular preference being given to talc [CAS No. 14807-96-6], especially microcrystalline talc. Talc is a sheet silicate having the chemical composition Mg₃[Si₄O₁₀(OH)₂], which, according to the polymorph, crystallizes as talc-IA in the triclinic crystal system or as talc-2M in the monoclinic crystal system (http://de.wikipedia.org/wiki/Talkum). Talc for use in accordance with the invention can be purchased, for example, as Mistron® RIO from Imerys Talc Group, Toulouse, France (Rio Tinto Group).

Acid scavengers used are preferably hydrotalcite, chalk, boehmite or zinc stannate.

Plasticizers used are preferably dioctyl phthalate, dibenzyl phthalate, butyl benzyl phthalate, hydrocarbon oils or N-(n-butyl)benzenesulphonamide.

The additive used as elastomer modifier is preferably one or more graft polymer(s) E of

E.1 5% to 95% by weight, preferably 30% to 90% by weight, of at least one vinyl monomer onto

E.2 95% to 5% by weight, preferably 70% to 10% by weight, of one or more graft bases having glass transition temperatures of <10° C., preferably <0° C., more preferably <−20° C.

The graft base E.2 generally has a median particle size (d₅₀) of 0.05 to 10 μm, preferably 0.1 to 5 μm, more preferably 0.2 to 1 μm.

Monomers E.1 are preferably mixtures of

E.1.1 50% to 99% by weight of vinylaromatics and/or ring-substituted vinylaromatics (for example styrene, α-methylstyrene, p-methylstyrene, p-chlorostyrene) and/or (C₁-C₈)-alkyl methacrylates (for example methyl methacrylate, ethyl methacrylate) and

E.1.2 1% to 50% by weight of vinyl cyanides (unsaturated nitriles such as acrylonitrile and methacrylonitrile) and/or (C₁-C₅)-alkyl(meth)acrylates (for example methyl methacrylate, n-butyl acrylate, t-butyl acrylate) and/or derivatives (such as anhydrides and imides) of unsaturated carboxylic acids (for example maleic anhydride and N-phenylmaleimide).

Preferred monomers E.1.1 are selected from at least one of the monomers styrene, α-methylstyrene and methyl methacrylate; preferred monomers E.1.2 are selected from at least one of the monomers acrylonitrile, maleic anhydride and methyl methacrylate.

Particularly preferred monomers are E.1.1 styrene and E.1.2 acrylonitile.

Graft bases E.2 suitable for the graft polymers for use in the elastomer modifiers are, for example, diene rubbers, EP(D)M rubbers, i.e. those based on ethylene/propylene, and optionally diene, acrylate, polyurethane, silicone, chloroprene and ethylene/vinyl acetate rubbers.

Preferred graft bases E.2 are diene rubbers (for example based on butadiene, isoprene etc.) or mixtures of diene rubbers or copolymers of diene rubbers or mixtures thereof with further copolymerizable monomers (for example as per E.1.1 and E.1.2), with the proviso that the glass transition temperature of component E.2 is <10° C., preferably <0° C., more preferably <−10° C.

A particularly preferred graft base E.2 is pure polybutadiene rubber.

Particularly preferred polymers E are ABS polymers (emulsion, bulk and suspension ABS), as described, for example, in DE-A 2 035 390 (=U.S. Pat. No. 3,644,574) or in DE-A 2 248 242 (=GB-A 1 409 275) or in Ullmann, Enzyklopädie der Technischen Chemie [Encyclopedia of Industrial Chemistry], vol. 19 (1980), p. 280 ff. The gel content of the graft base E.2 is at least 30% by weight, preferably at least 40% by weight (measured in toluene). ABS means acrylonitrile-butadiene-styrene copolymer [CAS No. 9003-56-9] and is a synthetic terpolymer formed from the three different monomer types acrylonitrile, 1,3-butadiene and styrene. It is one of the amorphous thermoplastics. The ratios may vary from 15-35% acrylonitrile, 5-30% butadiene and 40-60% styrene.

The elastomer modifiers or graft copolymers E are prepared by free-radical polymerization, for example by emulsion, suspension, solution or bulk polymerization, preferably by emulsion or bulk polymerization.

Particularly suitable graft rubbers are also ABS polymers, which are prepared by redox initiation with an initiator system composed of organic hydroperoxide and ascorbic acid according to U.S. Pat. No. 4,937,285.

Since, as is well known, the graft monomers are not necessarily grafted completely onto the graft base in the grafting reaction, according to the invention, graft polymers B are also understood to mean those products which are obtained through (co)polymerization of the graft monomers in the presence of the graft base and occur in the workup as well.

Suitable acrylate rubbers are based on graft bases E.2, which are preferably polymers of alkyl acrylates, optionally with up to 40% by weight, based on E.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, especially preferably chloroethyl acrylate, and mixtures of these monomers.

For crosslinking, it is possible to copolymerize monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, for example ethylene glycol dimethacrylate, allyl methacrylate; polyunsaturated heterocyclic compounds, for example trivinyl cyanurate and triallyl cyanurate; polyfunctional vinyl compounds, such as di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5%, especially 0.05% to 2%, by weight, based on the graft base E.2.

In the case of cyclic crosslinking monomers having at least 3 ethylenically unsaturated groups, it is advantageous to restrict the amount to below 1% by weight of the graft base E.2.

Preferred “other” polymerizable, ethylenically unsaturated monomers which, alongside the acrylic esters, may optionally serve for preparation of the graft base E.2 are, for example, acrylonitrile, styrene, α-methylstyrene, acrylamide, vinyl C₁-C₆-alkyl ethers, methyl methacrylate, butadiene. Preferred acrylate rubbers as graft base E.2 are emulsion polymers having a gel content of at least 60% by weight.

Further suitable graft bases according to E.2 are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Irrespective of component c), additional fillers and/or reinforcers may be present as additives in the inventive compositions.

Preference is also given to using a mixture of two or more different fillers and/or reinforcers, especially based on talc, mica, silicate, quartz, wollastonite, kaolin, amorphous silicas, magnesium carbonate, chalk, feldspar, barium sulphate, glass beads and/or fibrous fillers and/or reinforcers based on carbon fibres. Preference is given to using mineral particulate fillers based on mica, silicate, quartz, wollastonite, kaolin, amorphous silicas, magnesium carbonate, chalk, feldspar or barium sulphate. Particular preference is given in accordance with the invention to using mineral particulate fillers based on wollastonite or kaolin.

Particular preference is additionally also given to using acicular mineral fillers as an additive. Acicular mineral fillers are understood in accordance with the invention to mean a mineral filler with a highly pronounced acicular character. One example is acicular wollastonites. The mineral preferably has a length:diameter ratio of 2:1 to 35:1, more preferably of 3:1 to 19:1., most preferably of 4:1 to 12:1. The median particle size of the inventive acicular minerals is preferably less than 20 μm, more preferably less than 15 μm, especially preferably less than 10 μm, determined with a CILAS GRANULOMETER.

As already described above for component c), in a preferred use form, the filler and/or reinforcer may have been surface-modified, more preferably with an adhesion promoter or adhesion promoter system, especially preferably based on silane. However, the pretreatment is not absolutely necessary.

For the modification of the fillers for use as additive, the silane compounds are generally used in amounts of 0.05% to 2% by weight, preferably 0.25% to 1.5% by weight and especially 0.5% to 1% by weight, based on the mineral filler for surface coating.

It is also possible for the particulate fillers for additional use as component h), as a result of the processing to give the moulding composition or shaped body, to have a lower d97 or d50 value in the moulding composition or in the shaped body than originally used.

### PREFERRED EMBODIMENTS

in a preferred embodiment, the present invention relates to compositions comprising PA66 and PA46, and also glass fibres and at least one thermal stabilizer selected from the group of the sterically hindered phenols of the formula (II)

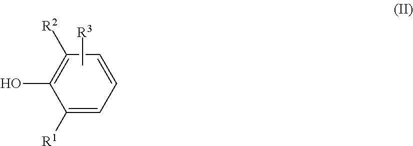

in which R¹ and R² are each an alkyl group, a substituted alkyl group or a substituted triazole group, where the R¹ and R² radicals may be the same or different and R¹ is an alkyl group, a substituted alkyl group, an alkoxy group or a substituted amino group, preferably at least one thermal stabilizer selected from the group of 2,2′-methylenebis(4-methyl-6-tert-butylphenol) 1,6-hexanediyl bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine, more preferably at least one thermal stabilizer selected from the group of 2,2′-methylenebis(4-methyl-6-tert-butylphenol), 1,6-hexanediyl bis[3-(3,5-di-tert-butyl-4-hydroxyphenyl)propionate](Irganox® 259), pentaerythrityl tetrakis[3-(3,5-di-tert-butyl-4-hydroxyphenyl)propionate] and N,N′-hexamethylenebis-3,5-di-tert-butyl-4-hydroxyhydrocinnamide (Irganox® 1098), especially N,N′-hexamethylenebis-3,5-di-tert-butyl-4-hydroxyhydrocinnamide.

In a preferred embodiment, the present invention relates to compositions comprising PA66 and PA6T/6, and also glass fibres and at least one thermal stabilizer selected from the group of the sterically hindered phenols of the formula (II)

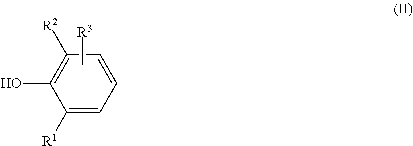

in which R¹ and R² are each an alkyl group, a substituted alkyl group or a substituted triazole group, where the R¹ and R² radicals may be the same or different and R³ is an alkyl group, a substituted alkyl group, an alkoxy group or a substituted amino group, preferably at least one thermal stabilizer selected from the group of 2,2′-methylenebis(4-methyl-6-tert-butylphenol), 1,6-hexanediyl bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine, more preferably at least one thermal stabilizer selected from the group of 2,2′-methylenebis(4-methyl-6-tert-butylphenol), 1,6-hexanediyl bis[3-(3,5-di-tert-butyl-4-hydroxyphenyl)propionate](Irganox® 259), pentaerythrityl tetrakis[3-(3,5-di-tert-butyl-4-hydroxyphenyl)propionate] and N,N′-hexamethylenebis-3,5-di-tert-butyl-4-hydroxyhydrocinnamide (Irganox® 1098), especially N,N′-hexamethylenebis-3,5-di-tert-butyl-4-hydroxyhydrocinnamide.

Uses

The present invention also relates to the use of the inventive compositions in the form of moulding compositions, for production of products resistant to heat distortion for short periods, preferably electric and electronic assemblies and components, especially preferably optoelectronic products.

Process

Moulding compositions for use in accordance with the invention for injection moulding or for extrusion are obtained by mixing the individual components of the inventive compositions, discharging them to form an extrudate, cooling the extrudate until it is pelletizable and pelletizing it.

Preference is given to mixing at temperatures in the range from 260 to 295° C. in the melt. Especially preferably, a twin-shaft extruder is used for this purpose.

In a preferred embodiment, the pellets comprising the inventive composition are dried at 80° C. in a dry air dryer or vacuum drying cabinet for about 2-6 h, before being subjected to the injection moulding operation or an extrusion process for the purpose of producing products.

The present invention also relates to a process for producing products, preferably products resistant to heat distortion for short periods, for the electrics or electronics industry, more preferably electronic or electrical assemblies and components, wherein the matrix material is obtained as a moulding composition comprising the inventive compositions by injection moulding or extrusion, preferably by injection moulding.

The present invention also relates to a process for improving the short-term heat distortion resistance of polyamide-based products, characterized in that inventive compositions in the form of moulding compositions are processed by injection moulding or extrusion.

The processes of injection moulding and extrusion of thermoplastic moulding compositions are known to those skilled in the art.

Inventive processes for producing products by extrusion or injection moulding work at melt temperatures in the range from 260 to 330° C., preferably in the range from 265 to 300° C., more preferably in the range from 275 to 295° C., and optionally additionally at pressures of not more than 2500 bar, preferably at pressures of not more than 2000 bar, more preferably at pressures of not more than 1500 bar and most preferably at pressures of not more than 750 bar.

Sequential coextrusion involves expelling two different materials successively in alternating sequence. In this way, a preform having a different material composition section by section in extrusion direction is formed. It is possible to provide particular article sections with specifically required properties through appropriate material selection, for example for articles with soft ends and a hard middle section or integrated soft bellows regions (Thielen, Hartwig, Gust, “Blasformen von Kunststoffhohlkörpern” [Blow-Moulding of Hollow Plastics Bodies]. Carl Hanser Verlag, Munich 2006, pages 127-129).

The process of injection moulding features melting (plasticization) of the raw material, preferably in pellet form, in a heated cylindrical cavity, and injection thereof as an injection moulding material under pressure into a temperature-controlled cavity. After the cooling (solidification) of the material, the injection moulding is demoulded.

The following phases are distinguished:

1. Plasticization/melting

2. Injection phase (filling operation)

3. Hold pressure phase (owing to thermal contraction in the course of crystallization)

4. Demoulding.

An injection moulding machine consists of a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the powder or the pellets, to meter them, to inject them and to maintain the hold pressure (owing to contraction). The problem of the melt flowing backward within the screw (leakage flow) is solved by non-return valves.

In the injection mould, the incoming melt is then separated and cooled, and hence the product to be produced is produced. Two halves of the mould are always needed for this purpose. In injection moulding, the following functional systems are distinguished:
runner system
shaping inserts
venting
machine casing and force absorber
demoulding system and movement transmission
temperature control

In contrast to injection moulding, extrusion uses a continuous shaped polymer extrudate, a polyamide here, in the extruder, the extruder being a machine for producing shaped thermoplastics. A distinction is made between single-screw extruders and twin-screw extruders, and also the respective sub-groups of conventional single-screw extruders, conveying single-screw extruders, contra-rotating twin-screw extruders and co-rotating twin-screw extruders.

Extrusion systems consist of extruder, mould, downstream equipment, extrusion blow moulds. Extrusion systems for production of profiles consist of: extruder, profile mould, calibration, cooling zone, caterpillar take-off and roll take-off, separating device and tilting chute.

The present invention consequently also relates to products, especially to products resistant to heat distortion for short periods, obtainable by extrusion, preferably profile extrusion, or injection moulding of the moulding compositions obtainable from the inventive compositions.

The present invention also relates to a process for producing products resistant to heat distortion for short periods, characterized in that the PA66 is processed to give moulding compositions in combination with compositions comprising, at least one thermoplastic polyamide from the group of nylon-4,6 or of the semiaromatic copolyamides with terephthalic acid having a melting point in the range from 270° C. to 330° C., in an injection moulding operation or by means of extrusion.

The present invention also relates to a process for producing products resistant to heat distortion for short periods, characterized in that compositions comprising PA66 in combination with nylon-4,6 are processed to become moulding compounds that are subjected to in an injection moulding operation or by means of extrusion.

The present invention preferably relates to a process for producing products resistant to heat distortion for short periods, characterized in that compositions comprising
a) 15% to 90% by weight, preferably 20% to 70% by weight, more preferably 30% to 60% by weight, of nylon-6,6.
b) 3% to 30% by weight, preferably 5% to 25% by weight, more preferably 10% to 20% by weight, of at least one thermoplastic polyamide from the group of nylon-4,6 and/or the semiaromatic copolyamides containing terephthalic acid as monomer unit and having a melting point in the range from 270° C. to 330° C., where the proportion of component b) or components b), based on the sum total of all the thermoplastic polymers present in the composition, is 5% to 40% by weight, preferably 10% to 30% by weight, more preferably 15%-25% by weight,
c) 5% to 70% by weight, preferably 10% to 45% by weight, more preferably 15% to 35% by weight, of glass fibres, and
d) 0.01% to 3% by weight, preferably 0.05% to 1.5% by weight, more preferably 0.1% to 0.8% by weight, of at least one thermal stabilizer,
   where the sum total of all the percentages by weight is always 100, are processed to give moulding compositions and these are subjected to an injection moulding operation or to an extrusion operation.

The present invention preferably relates to a process for producing products resistant to heat distortion for short periods, characterized in that compositions comprising

a) 15% to 91.99% by weight, preferably 20% to 70% by weight, more preferably 30% to 60% by weight, of nylon-6,6,
b) 3% to 30% by weight, preferably 5% to 25% by weight, more preferably 10% to 20% by weight, of nylon-4,6,
c) 5% to 70% by weight, preferably 10% to 45% by weight, more preferably 15% to 35% by weight, of glass fibres, and
d) 0.01% to 3% by weight, preferably 0.05% to 1.5% by weight, more preferably 0.1% to 0.8% by weight, of at least one thermal stabilizer,
where the sum total of all the percentages by weight is always 100, are processed to give moulding compositions and these are subjected to an injection moulding operation or to an extrusion operation.

The products obtainable by the processes mentioned surprisingly exhibit excellent short-term heat resistance, especially in soldering operations, and optimized properties in the mechanical properties. The moulding compositions that can be produced from the inventive compositions for injection moulding and extrusion additionally feature good processibility compared to the prior art.

The present invention also relates to the use of the inventive compositions for enhancing the short-term heat distortion resistance of products, preferably of products for the electrics or electronics industry, especially of optoelectronic products.

The products produced in this way are therefore of excellent suitability for electric or electronic products, especially electronic components which are applied to circuit boards, for example housings for coil formers, transistors, switches and plug connectors, but also for optoelectronic products, especially LEDs or OLEDs. A light-emitting diode (also called luminescence diode, LED) is an electronic semiconductor component. If current flows through the diode in forward direction, it emits light, infrared radiation (in the form of an infrared light-emitting diode) or else ultraviolet radiation with a wavelength dependent on the semiconductor material and the doping. An organic light-emitting diode (OLED) is a thin-film light-emitting component composed of organic semiconductor materials, which differs from the inorganic light-emitting diodes (LEDs) in that the current density and luminance are lower, and monocrystalline materials are not required. Compared to conventional (inorganic) light, emitting diodes, organic light-emitting diodes are therefore less expensive to produce, but their lifetime is currently shorter than the conventional light-emitting diodes.

### EXAMPLES

To produce the compositions described in accordance with the invention, the individual components were mixed in a twin-shaft extruder (ZSK 26 Mega Compounder from Coperion Werner & Pfleiderer (Stuttgart. Germany)) at temperatures between 275 and 295° C. in the melt and discharged as an extrudate, and the extrudate was cooled until pelletizable and pelletized. Before further steps, the pelletized material was dried at 80° C. in a vacuum drying cabinet for about 2-6 h.

The sheets and test specimens for the studies listed in Table 1 were injection-moulded on a conventional injection moulding machine at a melt temperature of 280-290° C. and a mould temperature of 80-120° C.

Flexural Strength, Flexural Modulus and Glow Wire Ignition Temperature

The testing for flexural strength (unit: MPa) and for flexural modulus (unit: MPa) was effected in analogy to ISO 178. The determination of the glow wire ignition temperature (GWIT) was effected in analogy to IEC 60695-2-13, reported in degrees Celsius.

Heat Distortion Resistance

The testing of heat distortion resistance (heat deflection temperature, HDT) (unit: ° C.) was effected in analogy to ISO 75 with a flexural stress of 1.8 N/mm² (Method A).

Short-Term Heat Distortion Resistance

The test for determining short-term heat distortion resistance or solder bath resistance simulates the conditions of wave soldering as follows:

Test specimens of dimensions 20*13*1.5 mm (length*width*height) were cut out of a sheet produced from moulding compositions based on an inventive composition. These were introduced on a glass plate into a conventional hot air oven heated at the temperature specified in Table 1 for 15 min. After cooling to room temperature, the shape retention of the test specimens was assessed with respect to the retention of the original size ratios and the extent of adhesion to the glass plate.

The results and test results are shown in Table 1. In this table:

“+” means a sample without any change in shape, i.e. more particularly without any rounding of the edges and corners of the test specimen, and detachment of the test specimen from the glass plate on inclination of the glass plate from the horizontal by 90° to the vertical, i.e. no adhesion of the test specimen.

“o” means a sample with a slight change in shape, which is manifested in slightly rounded edges and corners, i.e. with edge radii of not more than 0.8 mm, although there is still no detectable adhesion of the test specimen on inclination of the glass plate from the horizontal by 90° to the vertical.

“-” means a highly deformed surface geometry of the test specimen, more particularly complete rounding of the edges and corners of the test specimen, i.e. with edge radii greater than 0.8 mm, and/or adhesion of the test specimen to the glass plate after inclination of the glass plate from the horizontal by 90 to the vertical.

Feedstocks

Component a):

PA66 (Durethan® A30 000000, Lanxess Deutschland GmbH. Cologne, Germany) Component b): PA46 (Stanyl® TE300 from DSM Engineering Plastics, Sittard, the Netherlands)

Component c):

glass fibres having a diameter of 10 plm, coated with a slip containing silane compounds (CS 7967, commercial product from Lanxess N.V., Antwerp, Belgium)

Component d):

Irganox® 1098 from BASF SE, Ludwigshafen, Germany

Component f):

flame retardant combination consisting of 75% Exolit® OP1230 from Clariant International Ltd., Muttenz, Switzerland, 20% Melapur® 200/70 from BASF SE, Ludwigshafen, Germany and 5% Firebrake 500 (from RioTinto Minerals, Greenwood Village, USA)

Component h):

further additives commonly used in polyamides, especially titanium dioxide, but also demoulding agents, especially ethylenebisamide tetrastearate, nucleating agent, especially based on talc. The type and amount of the additives referred to collectively as component h) corresponded in terms of type and amount for the examples and comparative examples.

Table 1 shows that, for thermally sensitive flame retardant systems such as component f), only in the case of the inventive polyamide blends are both good processibility and elevated short-term heat distortion resistance found at temperatures above the melting point of component a). This is an important prerequisite for applications which, like electronic components for example, can be exposed briefly to solder bath temperatures up to 285° C. Other findings are elevated glow wire ignitability and more advantageous mechanical properties in the case of use of the inventive compositions and products that can be produced therefrom.

TABLE 1
Polyamide blends comprising thermally sensitive flame retardants

| | Comp. 1 | Comp. 2 | Ex. 1 | Ex. 2 |
|---|---|---|---|---|
| Component a) | 50.7 | 10.7 | 40.7 | 35.7 |
| Component b) | | 40 | 10 | 15 |
| Component c) | 30 | 30 | 30 | 30 |
| Component d) | 0.5 | 0.5 | 0.5 | 0.5 |
| Component f) | 18.5 | 18.5 | 18.5 | 18.5 |
| Component h) | 0.3 | 0.3 | 0.3 | 0.3 |
| GWIT at 1.5 mm [° C.] | 725 | * | 750 | 775 |
| Flexural modulus [MPa] | 10353 | * | 10535 | 10641 |
| Flexural strength [MPa] | 225 | * | 229 | 233 |
| HDT A [° C.] | 242 | * | 244 | 245 |
| Short-term heat distortion | + | * | + | + |
| resistance | | | | |
| at 265° C. | | | | |
| Short-term heat distortion | ∘ | * | + | + |
| resistance at 275° C. | | | | |
| Short-term heat distortion | − | * | ∘ | ∘ |
| resistance at 285° C. | | | | |
| Short-term heat distortion | − | * | ∘ | ∘ |
| resistance at 295° C. | | | | |
| Processihility at 290° C. | + | − | + | + |

* No test specimens were producible because of difficult processibility; the figures given for the individual components are in % by weight.

What is claimed is:

1. Compositions comprising:
a) 15% to 90% by weight of nylon-6,6,
b) 3% to 30% by weight of at least one thermoplastic polyamide from the group of nylon-4,6 and/or the semiaromatic copolyamides containing terephthalic acid as monomer unit and having a melting point in the range from 270° C. to 330° C., where the proportion of component b) or components b), based on the sum total of all the thermoplastic polymers present in the composition, is 5% to 40% by weight,
c) 5% to 70% by weight of glass fibres, and
d) 0.01% to 3% by weight of at least one thermal stabilizer, where the sum total of all the percentages by weight is always 100.

2. Compositions according to claim 1, wherein they comprise, in addition to components a), b), c) and d), also e) 0.01% to 5% by weight of dipentaerythritol and/or tripentaerythritol, in which case the levels of the other components are reduced to such an extent that the sum total of all the percentages by weight is always 100.

3. Compositions according to claim 2, wherein they comprise, in addition to components a), b), c), d) and e) or instead of e), also f) 1% to 55% by weight of at least one flame retardant, in which case the levels of the other components are reduced to such an extent that the sum total of all the percentages by weight is always 100.

4. Compositions according to claim 3, wherein they comprise, in addition to components a) to f) or instead of components e) and/or f), also g) 0.01% to 10% by weight of at least one additive having two epoxy groups per molecule, in which case the levels of the other components are reduced to such an extent that the sum total of all the percentages by weight is 100.

5. Compositions according to claim 4, wherein they comprise, in addition to components a) to g) or instead of components e) and/or f) and/or g), also h) 0.01% to 20% by weight of at least one additive other than components c) to g), in which case the levels of the other components are reduced to such an extent that the sum total of all the percentages by weight is 100.

6. Compositions according to claim 1, wherein the thermal stabilizers are selected from the group of the sterically hindered phenols, these being compounds having phenolic structure and having at least one sterically demanding group on the phenolic ring, sterically demanding groups being tert-butyl groups, isopropyl groups and aryl groups substituted by sterically demanding groups.

7. Compositions according to claim 6, wherein the thermal stabilizers contain at least one structure of the formula (II) 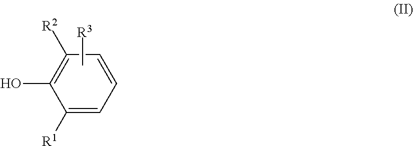
in which R¹ and R² are each an alkyl group, a substituted alkyl group or a substituted triazole group, where the R¹ and R² radicals may be the same or different and R³ is an alkyl group, a substituted alkyl group, an alkoxy group or a substituted amino group.

8. Compositions according to claim 6, where the thermal stabilizers used are sterically hindered phenols derived from substituted benzenecarboxylic acids.

9. Compositions according to claim 8, where the thermal stabilizer is from substituted benzenepropionic acids.

10. Compositions according to claim 9, where the thermal stabilizer is a compound of the formula (III) 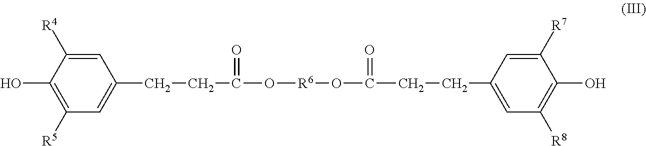
where R, R⁵, R⁷ and R⁸ are each independently C₁-C₈-alkyl groups which may themselves be substituted (at least one of these is a sterically demanding group) and R⁶ is a divalent aliphatic radical having 1 to 10 carbon atoms, which may also have C—O bonds in the main chain.

11. Compositions according to claim 8, wherein the thermal stabilizers are selected from the group of 2,2′-methylenebis(4-methyl-6-tert-butylphenol), 1,6-hexanediyl bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

12. Compositions according to claim 6, wherein the thermal stabilizers are selected from the group of 2,2′-methylenebis(4-methyl-6-tert-butylphenol), 1,6-hexanediyl bis[3-(3,5-di-tert-butyl-4-hydroxyphenyl)propionate], pentaerythrityl tetrakis[3-(3,5-di-tert-butyl-4-hydroxyphenyl)propionate] and N,N′-hexamethylenebis-3,5-di-tert-butyl-4-hydroxyhydrocinnamide.

13. Compositions according to claim 5, characterized in that the pigment titanium dioxide is used as additive.

14. Products obtainable by extrusion or injection moulding of moulding compositions comprising the compositions according to claim 1.

15. Products according to claim 14, characterized in that they are products having short-term heat distortion resistance for the electrics or electronics industry.

16. Process for producing products having short-term heat distortion resistance, characterized in that compositions according to claim 1 are processed to give moulding compositions and these are subjected to an injection moulding or extrusion operation.
